(19) United States
(12) Patent Application Publication
(10) Pub. No.: US 2020/0406776 A1
(43) Pub. Date: Dec. 31, 2020

(54) Energy Management System

(71) Applicant: Marelli Corporation, Saitama-city, Saitama (JP)

(72) Inventor: Teruyoshi Mihara, Saitama-city, Saitama (JP)

(21) Appl. No.: 16/957,238

(22) PCT Filed: Sep. 28, 2018
(86) PCT No.: PCT/JP2018/036426

§ 371 Date: Jun. 23, 2020

(30) Foreign Application Priority Data
Dec. 26, 2017 (JP) 2017-250187

(51) Int. Cl. B60L 53/62; B60L 50/90; B60L 58/12; B60L 50/60; B60L 58/26; B60L 58/27

(52) U.S. Cl. CPC B60L 53/62; B60L 50/90; B60L 58/27; B60L 50/60; B60L 58/26; B60L 58/12

(57) ABSTRACT

An energy management system comprises a battery, a heat storage unit, a cold storage unit and a control device. The control device distributes electric power (electric energy) inputted into the energy management system 1 among the battery, the heat storage unit and the cold storage unit by referring to a charging state (SOC and SOP) of the battery, a heat storage state to the heat storage unit and a cold storage state to the cold storage unit. The inputted electric energy is converted into chemical energy to be stored in the battery, and on the other hand, is converted into thermal energy to be stored in the heat storage unit and the cold storage unit.

### CROSS-REFERENCE TO RELATED APPLICATION(S)

This application is a national stage 371 application of PCT/JP2018/036426, filed on Sep. 28, 2018, which claims priority to and the benefit of Japanese Application Patent Serial No. 2017-250187, filed Dec. 26, 2017, the entire disclosures of which are hereby incorporated by reference.

### TECHNICAL FIELD

The present invention relates to an energy management system that integrally manages thermal energy and electric energy.

### BACKGROUND

Japanese Patent Laid-Open No. 2013-115996 A discloses that electric power (electric energy) generated by power generator is charged to a battery to be stored as chemical energy and also is converted into thermal energy for storage.

### SUMMARY

In Japanese Patent Laid-Open No. 2013-115996 A, an electrical heater is driven by the generated electric power to heat water high in specific heat and convert the electric power into the thermal energy. In addition, it is suggested to use the obtained thermal energy to respond to heat supply to air conditioning equipment or heat demands such as heating.

In Japanese Patent Laid-Open No. 2013-115996 A, the electric power (electrical energy) is simply distributed to the battery and the electric heater. Here, in terms of use efficiency of the electric power (electrical energy), a method for the use of the electric power has room for improvement.

Therefore, it is required that the electric power can be efficiently used.

The present invention provides an energy management system comprising: a battery; a heat storage unit; a cold storage unit; and a controller, wherein, when a regeneration power inputted into the energy management system from a power supply source exceeds a chargeable and dischargeable electric power of the battery while a charged amount of the battery has not reached to an upper limit, the controller is configured to distribute electric power inputted into the energy management system among the battery, the heat storage unit and the cold storage unit by referring to: the charged amount and the chargeable and dischargeable electric power of the battery; a heat storage state of the heat storage unit; and a cold storage state of the cold storage unit, and wherein the electric power equivalent to the amount exceeding the chargeable and dischargeable electric power is distributed between the heat storage unit and the cold storage unit.

According to the present invention, the electric power can be efficiently used.

### BRIEF DESCRIPTION OF THE DRAWINGS

FIG. 1 is a schematic diagram of an energy management system;

FIG. 2 is a diagram explaining a configuration example in a thermal conversion device side of the energy management system;

FIG. 3 is a diagram explaining a Peltier heat exchanger;

FIG. 4 is a schematic diagram of an energy management system mounted on a vehicle;

FIG. 5 is a diagram explaining distribution of electric power by a control device;

FIG. 6 is a time chart explaining a relation between a change in a running state of a vehicle and the distribution of the electric power;

FIG. 7A is a diagram explaining an engine efficiency map;

FIG. 7B is a diagram explaining an engine efficiency map;

FIG. 8 is a diagram explaining a case where the thermal conversion device is a hot water heater;

FIG. 9 is a diagram explaining a case where the thermal conversion device is an electric heater in a desiccant system; and

FIG. 10 is a diagram explaining a distribution ratio of the electric power.

### DETAILED DESCRIPTION

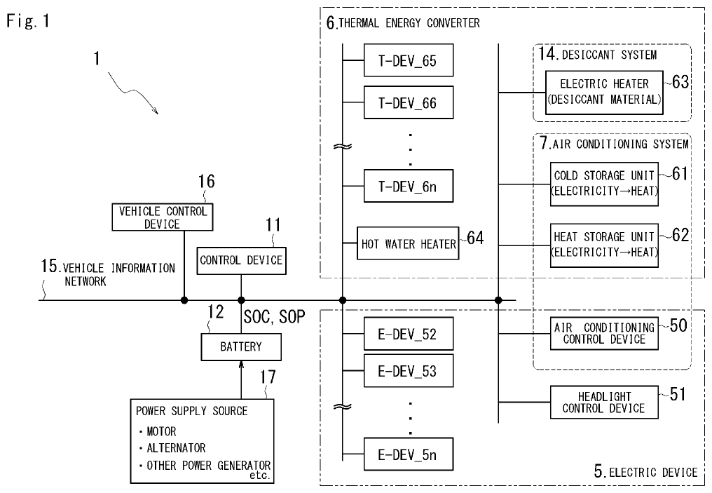

Hereinafter, an explanation will be made of an embodiment of the present invention by taking a case of an energy management system 1 mounted on a vehicle as an example. FIG. 1 is a schematic diagram of the energy management system 1.

In the energy management system 1, a control device 11, a battery 12, a plurality of electric devices 5 and a plurality of thermal energy converter 6 are connected via a vehicle information network 15 to be capable of exchanging information.

A vehicle control device 16 is further connected to the vehicle information network 15. The vehicle control device 16 is a control device higher in performance than the control device 11. The vehicle control device 16 controls an entire vehicle including running control of the vehicle in accordance with a state of the vehicle.

The control device 11 performs the energy management in the entire vehicle including the thermal energy converter 6-side (thermal conversion side) in cooperation with power supply sources 17 (regeneration electric system). The control device 11 outputs energy information to the vehicle control device 16.

Here, the energy information indicates an electric power amount, which can be accepted and stored in the energy management system 1, in the electric power (electrical energy) generated in the power supply source 17 (regeneration electric system). The energy information includes the following information, for example.

(a) Information indicating an amount of electric energy (electric power amount) that can be converted into thermal energy and stored by a later-described storage unit (a cold storage unit 61 or heat storage unit 62) for thermal energy.
(b) Information indicating an amount of electric energy (electric power amount) that can be converted into chemical energy and stored in the battery 12

The power supply sources 17 generate electric power by using rotation energy (regeneration energy) at the deceleration running of a vehicle, for example. A motor for vehicle drive, an alternator, a flywheel and other on-vehicle power generators are exemplified as the power supply sources 17.

The battery 12 is connected electrically to the power supply sources 17 and stores the electric power (electric energy) generated in the power supply sources 17 as the chemical energy, and on the other hand, converts the stored chemical energy into electric power for output. Here, a lithium-ion secondary cell, a lead battery and so on are exemplified as the battery 12. It should be noted that the other devices may be used as long as they can store the electric power (electric energy) as the chemical energy and output the stored chemical energy as the electric power.

A battery for 12V series, a battery for 24V series, a battery for 48V series and a battery for 200V series are exemplified as the battery 12.

The battery 12 outputs, for example, the following information via the vehicle information network 15 to the control device 11 and the vehicle control device 16.

(a) Information indicating an SOC (a charging rate: State of charge) of the battery 12
(b) Information indicating an SOP (a charge/discharge possible electric power: State of power) of the battery 12
(c) Information indicating a temperature of the battery 12

The electric devices 5 are on-vehicle equipment that is driven by electric power supplied from the battery 12. It should be noted that in a case where the battery 12 is the battery for 48V series or 200V series, the output of the battery is reduced in electric power as needed, and after that, is supplied to the electric devices 5. An air conditioning control device 50 for controlling an air conditioning system 7 for vehicle, a headlight control device 51 and the like are exemplified as the electric devices 5. It should be noted that in FIG. 1, the electric devices 5 include devices as well indicated at code E-DEV_5n (“n” is any integral number of 2 or more).

The thermal energy converter 6 are the equipment that is driven by the electric power supplied from the battery 12 to convert the electric energy into the thermal energy or the equipment using the converted thermal energy.

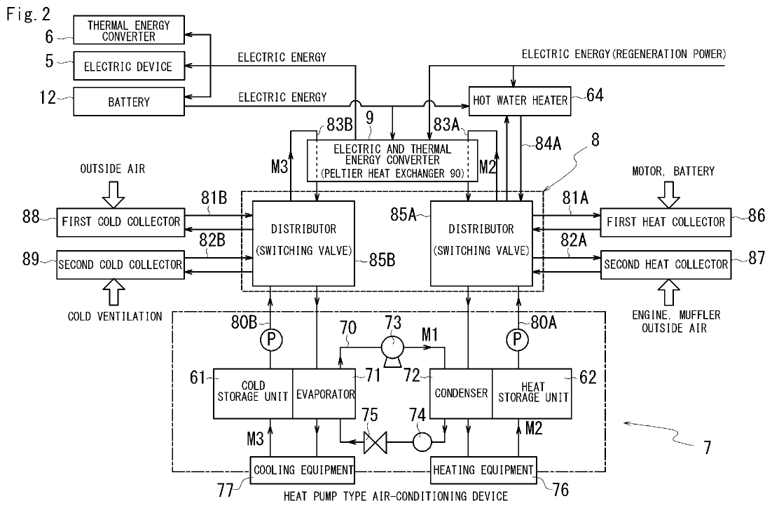

An electric heater 63 in a desiccant system 14, a hot water heater 64 and the like are exemplified as the thermal energy converter 6. Further, the thermal energy converter 6 include an electric and thermal energy converter 9 (refer to FIG. 2), and a Peltier heat exchanger 90 that can heat and cool heat exchange media M2, M3 in the air conditioning system 7 for vehicle is exemplified as the electric and thermal energy converter 9.

The cold storage unit 61 attached to an evaporator 71 in the air conditioning system 7 and the heat storage unit 62 attached to a condenser 72 in the air conditioning system 7 are exemplified as the equipment using the converted thermal energy (refer to FIG. 2). It should be noted that in FIG. 1, devices indicated at code T-DEV_6n (“n” is any integral number of 5 or more) are also included in the thermal energy converter 6.

In the energy management system 1, the control device 11 integrally manages the thermal energy and the electric energy based upon taking the thermal energy and the electric energy as a single energy grid for maximizing an energy efficiency in the entire system. Therefore, the control device 11 is a controller of the system (thermal and electric energy management system) that manages the thermal energy and the electric energy.

Specifically the control device 11 distributes the electric power inputted into the energy management system 1 between the battery 12 and the thermal energy converter 6. Thereby the electric energy distributed to the battery 12 is stored in the battery 12 as the chemical energy, which can be taken out as the electric energy when needed.

Further, the electric energy distributed to the thermal energy converter 6 is converted into the thermal energy by the thermal energy converter 6, which thereafter is stored in the heat storage equipment (the cold storage unit 61 and the heat storage unit 62) and can be taken out as the thermal energy or the electric energy when needed.

Therefore, in the energy management system 1, the inputted electric power (electric energy) can be taken out for use in the entirety of the energy management system 1 when needed without being wasted.

The following information is inputted via the vehicle information network 15 into the control device 11.

(a) Electric consumption information of each of the electric devices 5
(b) Information indicating a state of the battery 12.
(b) Information indicating a state of the heat storage equipment (the cold storage unit 61 and the heat storage unit 62) that heat-stores the thermal energy generated by each of the thermal energy converter 6.

The electric consumption information of the electric devices 5 includes information indicating a current value, an operating state, a power consumption amount and an electric load of each of the driving electric devices 5.

The information indicating the state of the battery 12 includes an SOC (a charging rate: State of charge) of the battery 12, an SOP (chargeable and dischargeable power: State of power) of the battery 12 and a temperature of the battery 12. The SOP of the battery 12 is a maximum value of a current value or a voltage value that can be inputted into/outputted from the battery 12, and is a variable changing in accordance with the SOC of the battery 12.

A signal indicating the state of the heat storage equipment includes information indicating a temperature of a heat storage material and an amount of the heat storage material in the heat storage equipment (the cold storage unit 61 and the heat storage unit 62).

The control device 11 distributes the electric power (electric energy) inputted from the power supply sources 17 between the battery 12 and the thermal energy converter 6, based upon these pieces of the inputted information. In addition, the control device 11 distributes the electric power (electric energy) to the electric devices 5 as well, as needed.

As a result, even in a case where the charge to the battery 12 cannot be performed due to the SOC (charging rate) of the battery 12 having reached the upper limit, the inputted electric energy can be used for the drive of each of the electric devices 5 or for the conversion to the thermal energy in the thermal energy converter 6. Thereby the inputted electric power (electric energy) can be consumed within the energy management system 1 without being wasted.

FIG. 2 is a diagram explaining a configuration example in the thermal conversion device side of the energy management system 1. In FIG. 2, a case where the thermal conversion device is the air conditioning system 7 for vehicle is shown as an example and an example of management for the electric energy and the thermal energy using this air conditioning system 7 is shown.

The air conditioning system 7 for vehicle is a so-called heat-pump type air conditioning device. In the air conditioning system 7, the evaporator 71 and the condenser 72 are disposed on a circulation path 70 of the heat exchange medium M1. A compressor 73 is disposed between the evaporator 71 and the condenser 72. The compressor 73 compresses the heat exchange medium M1 to adjust the heat exchange medium M1 having a high temperature and a high pressure and supplies the adjusted heat exchange medium M1 to the condenser 72.

The heat exchange between the heat exchange medium M1 having the high temperature and the high pressure and the heat exchange medium M2 is performed in the condenser 72. In the condenser 72, the heat exchange medium M1 is condensed from a gas state at a high temperature and at a high pressure to a liquid state at a high temperature by heat exchange with the heat exchange medium M2. Further, the heat exchange medium M2 flowing in the condenser 72 is heated by the heat exchange with the heat exchange medium M1.

The heat storage unit 62 is attached to be heat-exchangeable with the condenser 72. A heat storage material (not shown) is filled inside of the heat storage unit 62, and high-temperature thermal energy of the heat exchange medium M2 heated by the heat exchange with the heat exchange medium M1 is stored in the heat storage unit 62. Here, an example of the heat storage material may include water, antifreeze liquid, paraffin or the like. The heat storage material has preferably fluid nature and may be a material having a change of phase.

A liquid tank 74 and an expansion valve 75 are disposed downstream of the condenser 72 in the circulation path 70. The liquid tank 74 stores therein the heat exchange medium M1 condensed in the condenser 72 and separates the heat exchange medium M1 into gas and liquid. The expansion valve 75 depressurizes the heat exchange medium M1 supplied from the liquid tank 74-side.

The evaporator 71 evaporates the heat exchange medium M1 supplied from the expansion valve 75-side under reduced pressure. Thereby, the heat exchange medium M1 changes from a liquid state to a gas state. Further, in the evaporator 71, the heat exchange medium M3 is cooled by heat of evaporation at the time the heat exchange medium M1 vaporizes.

The cold storage unit 61 is attached to be heat-exchangeable with the evaporator 71. The cold storage material (not shown) is filled inside the cold storage unit 61, and low-temperature thermal energy of the heat exchange medium M3 cooled by heat exchange with the heat exchange medium M1 is stored in the cold storage unit 61. Here, for example, water or paraffin can be used as the cold storage material.

The heat exchange medium M1 that has become in the gas state in the evaporator 71 is again compressed in the compressor 73, and thereafter, is supplied to the condenser 72 in the gas state having the high-temperature and high-pressure. Accordingly, the heat exchange medium M1 circulates with repetition of compression and expansion in the circulation path 70.

Heating equipment 76 (a heater core), a pump P and a distributor 85A are disposed in a circulation path 80A for supply of the heat exchange medium M2 to the condenser 72. The heat exchange medium M2 in the circulation path 80A flows in the circulation path 80A by an ejection pressure of the pump P. The high-temperature heat exchange medium M2 is supplied to the heating equipment 76 (heater core) from the condenser 72-side. Air for air conditioning is heated by the thermal energy of the heat exchange medium M2 in the heating equipment 76.

A circulation path 81A passing through a first heat collector 86, a circulation path 82A passing through a second heat collector 87, a circulation path 83A passing through an electric and thermal energy converter 9 and a circulation path 84A passing through the hot water heater 64 are connected to the distributor 85A.

The first heat collector 86 heats the heat exchange medium M2 flowing in the circulation path 81A by using exhaust heat of the motor and the battery. The second heat collector 87 heats the heat exchange medium M2 flowing in the circulation path 82A by using exhaust heat of an engine and a muffler (an exhaust gas) or heat of outside air. Accordingly, a part of the thermal energy mostly disposed of without being used is collected into the heat exchange medium M2.

The electric and thermal energy converter 9 converts the electric energy into the thermal energy, and the converted thermal energy heats the heat exchange medium M2 flowing in the circulation path 83A. The hot water heater 64 drives the heater by the electric power supplied from the battery 12 and/or the regeneration power generated at the deceleration running of a vehicle or the like to heat the heat exchange medium M2.

The distributor 85A has a function of a switching valve that switches the destination of the circulation path 80A among the circulation paths 81A, 82A, 83A, 84A, and is driven by the control device 11. The control device 11 controls the distributor 85A to switch the destination of the circulation path 80A among the circulation paths 81A, 82A, 83A, 84A for meeting the following conditions.

(a) A temperature of the heat exchange medium M2 to be supplied to the condenser 72 is lower than that of the heat exchange medium M1 to be supplied from the compressor 73.

(b) A temperature of the heat exchange medium M2 heated by heat exchange in the condenser 72 is equal to that required for heating air-conditioning air in the heating equipment 76.

(c) A temperature of the heat exchange medium M2 after passing through the heating equipment 76 is higher than a heat storage temperature in the heat storage unit 62.

(d) A temperature of the heat exchange medium M1 cooled by heat exchange in the condenser 72 is equal to a lower temperature suitable for vaporization in the evaporator 71.

The heat exchange medium M2 is heated by any one of the first heat collector 86, the second heat collector 87, the electric and thermal energy converter 9 and the hot water heater 64 and also is heated to a higher temperature by heat exchange with the high-temperature and high-pressure heat exchange medium M1. Then, the heat exchange medium M2 heated to a higher temperature is supplied to the heat storage unit 62.

A cooling equipment 77 (a cooler core), the pump P and a distributor 85B are disposed in a circulation path 80B for supply of the heat exchange medium M3 to the evaporator 71. The heat exchange medium M3 in the circulation path 80B flows in the circulation path 80B by an ejection pressure of the pump P. The low-temperature heat exchange medium M3 is supplied to the cooling equipment 77 (cooler core) from the evaporator 71-side. The air for air conditioning is cooled by the thermal energy of the low-temperature heat exchange medium M3 in the cooling equipment 77.

A circulation path 81B passing through a first cold collector 88, a circulation path 82B passing through a second cold collector 89 and a circulation path 83B passing through the electric and thermal energy converter 9 are connected to the distributor 85B.

The first cold collector 88 cools the heat exchange medium M3 flowing in the circulation path 81B by using a heat quantity of outside air. The second cold collector 89 cools the heat exchange medium M3 by using a heat quantity of air (cold ventilation) that cools the inside of a vehicle compartment and then is discharged outside of a vehicle. Accordingly, a part of the thermal energy used for the cooling of the vehicle compartment is collected into the heat exchange medium M3.

The electric and thermal energy converter 9 converts the electric energy into the thermal energy, and the converted thermal energy cools the heat exchange medium M3 flowing in the circulation path 83B.

The distributor 85B has a function of a switching valve that switches the destination of the circulation path 80B among the circulation paths 81B, 82B, 83B and is driven by the control device 11. The control device 11 controls the distributor 85B to switch the destination of the circulation path 80B among the circulation paths 81B, 82B, 83B for meeting the following conditions.

(a) A temperature of the heat exchange medium M3 to be supplied to the evaporator 71 is higher than that of the heat exchange medium M1 to be supplied from the expansion valve 75.

(b) A temperature of the heat exchange medium M3 heated by heat exchange in the evaporator 71 is equal to that required for cooling air-conditioning air in the cooling equipment 77.

(c) A temperature of the heat exchange medium M3 after passing through the cooling equipment 77 is lower than a cold storage temperature in the cold storage unit 61.

(d) A temperature of the heat exchange medium M1 subjected to heat exchange in the evaporator 71 is equal to a higher temperature suitable for compression in the compressor 73.

The heat exchange medium M3 is cooled by any one of the first cold collector 88, the second cold collector 89 and the electric and thermal energy converter 9 and also is cooled to a lower temperature by heat exchange with the heat exchange medium M1. Then, the heat exchange medium M3 cooled to a lower temperature is supplied to the cold storage unit 61. In the cold storage unit 61, a heat quantity of the heat exchange medium M3 is cold-stored in a cold storage material (not shown).

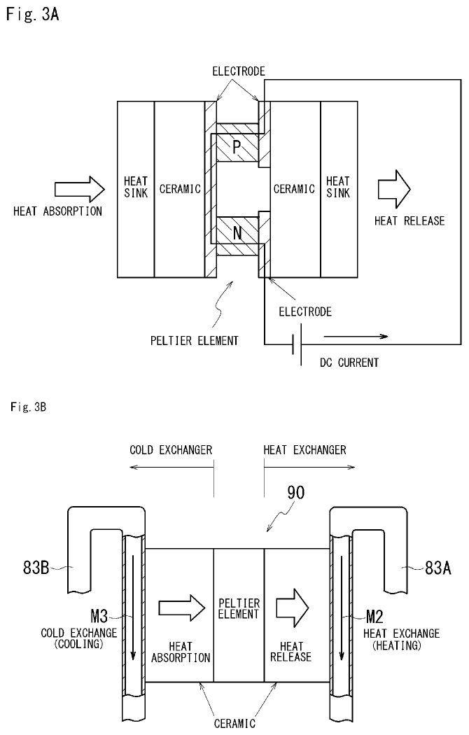

Here, in the present embodiment, a heat exchanger (Peltier heat exchanger 90) adopting a Peltier element is used as the electric and thermal energy converter 9. FIG. 3A and FIG. 3B are diagrams explaining the Peltier heat exchanger 90. FIG. 3A is a diagram explaining the principle of a Peltier element. FIG. 3B is a diagram explaining the configuration of the Peltier heat exchanger 90.

The Peltier element is a plate-shaped semiconductor using a Peltier effect that when current is caused to flow to a junction part between two kinds of metals, heat transfers from one metal to the other metal. In the Peltier element, causing the current to flow to P-type and N-type semiconductors generates transfer of heat, and a ceramic surface in contact with one electrode absorbs the heat and a ceramic surface in contact with the other electrode releases the heat.

In the Peltier heat exchanger 90 shown in FIG. 3B, the circulation path 83B is disposed to be heat-exchangeable in contact with the ceramic in the heat absorption side and the circulation path 83A is disposed to be heat-exchangeable in contact with the ceramic in the heat release side. In this Peltier heat exchanger 90, power supply to the Peltier element causes the heat exchange medium M3 flowing in the circulation path 83B in the heat absorption side to be cooled by cold exchange and the heat exchange medium M2 flowing in the circulation path 83A in the heat generation side to be heated by heat exchange.

Therefore, the Peltier heat exchanger 90 is configured such that as viewed from the Peltier element, part of the circulation path 83A-side functions as a heat exchanger and part of the circulation path 83B-side functions as a cold exchanger.

As shown in FIG. 2, the energy management system 1 is configured such that the regeneration power at the deceleration running of a vehicle and/or the electric power from the battery 12 is inputted into the electric and thermal energy converter 9 (Peltier heat exchanger 90). The Peltier heat exchanger 90 can simultaneously perform the heating of the heat exchange medium M2 and the cooling of the heat exchange medium M3 by power supply. Therefore the Peltier heat exchanger 90 is configured to simultaneously perform the conversion to the low-temperature thermal energy and the conversion to the high-temperature thermal energy from the electric energy.

Here, the heat exchange is made between the ceramics as both surfaces of the Peltier element and the liquid, in the Peltier heat exchanger 90. Therefore, a difference in temperature between one side ceramic and the other side ceramic of the Peltier element can be kept in an appropriate temperature. As a result, the conversion to the high-temperature thermal energy and the conversion to the low-temperature thermal energy from the electric energy can be efficiently performed.

In addition, the Peltier heat exchanger 90 outputs current (electric energy) by the Peltier effect when the high-temperature heat exchange medium M2 is caused to flow in the one circulation path 83A and the low-temperature heat exchange medium M3 is caused to flow in the other circulation path 83B in the non-power supply state. Therefore in the energy management system 1, the drive of the electric device 5, the charge to the battery 12, the drive of the other thermal energy converter 6, and the like can be performed by the electric power outputted from the Peltier heat exchanger 90.

Thereby, after the regeneration power (electric energy) at the deceleration running of a vehicle is converted into the thermal energy to be taken in, electric energy can be taken out of the taken-in thermal energy as needed.

In this way, according to the present embodiment, the exhaust heat from a variety of the equipment is collected into the heat exchange medium M2 using the first heat collector 86 and the second heat collector 87, and the regeneration power and the extra power generating in the electric line are collected into the heat exchange medium M2 using the electric and thermal energy converter 9 and the hot water heater 64. In addition, the exhaust heat from the variety of the equipment, the regeneration power and the extra power generating in the electric line are stored in the heat storage unit 62 as the high-temperature thermal energy.

Further, the cold heat collected from outside air and from cold ventilation from the vehicle compartment is collected into the heat exchange medium M3 using the first cold collector 88 and the second cold collector 89, and the regeneration power and the extra power generating in the electric line are stored into the heat exchange medium M3 using the electric and thermal energy converter 9. In addition, the cold heat collected from outside air and from cold ventilation of the vehicle compartment, and the regeneration power and the extra power generating in the electric line are stored into the cold storage unit 61 as the low-temperature thermal energy.

As a result, the collected high-temperature thermal energy and the collected low-temperature thermal energy are stored in the heat storage unit 62 and in the cold storage unit 61 in a state of being usable as an air conditioning heat source in the air conditioning system 7. Further, in a case where the electric and thermal energy converter 9 is the Peltier heat exchanger 90, the electric energy is taken out of the thermal energy stored in the heat storage unit 62 and in the cold storage unit 61.

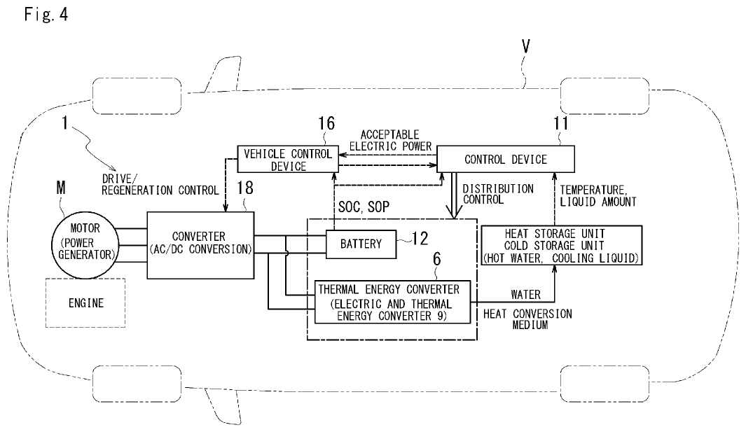

Hereinafter, a case where a vehicle V on which the energy management system 1 is mounted is an electric car to be driven by a motor M will be explained as an example. It should be noted that hereinafter, the explanation will be made assuming the vehicle V as the electric car, but the vehicle V may be even a hybrid vehicle equipped with both of an engine and the motor M. In a case of the hybrid vehicle, the engine surrounded by a broken line will be attached to the motor M in FIG. 4.

FIG. 4 is a schematic diagram of the energy management system 1 mounted on the vehicle V. As shown in FIG. 4, a converter 18 is disposed between the motor M and the battery 12 in the vehicle V. The converter 18 has a function of a converter that converts DC into AC of a variable voltage and a variable frequency and a function of a rectifier that converts AC into DC of a variable voltage.

The converter 18 controls a drive (rotation) of the motor M based upon an instruction from the vehicle control device 16 at the running (power running) of the vehicle V. The converter 18 controls power generation in the motor M based upon an instruction from the vehicle control device 16 at the deceleration running (regeneration) of the vehicle V.

At the deceleration running (regeneration) of the vehicle V, the motor M is driven with rotation energy to generate electric power. The electric power generated by the motor M is AC/DC-converted in the converter 18, which is thereafter distributed between the battery 12 and the thermal energy converter 6. The electric power (electric energy) inputted into the battery 12 is stored as the chemical energy. The electric power (electric energy) inputted into the thermal energy converter 6 is converted into the thermal energy to be stored in the heat storage equipment (the cold storage unit 61 and the heat storage unit 62). In addition, the thermal energy stored in the heat storage equipment (the cold storage unit 61 and the heat storage unit 62) is used mainly for the heating or cooling of air in the air conditioning system 7 for vehicle.

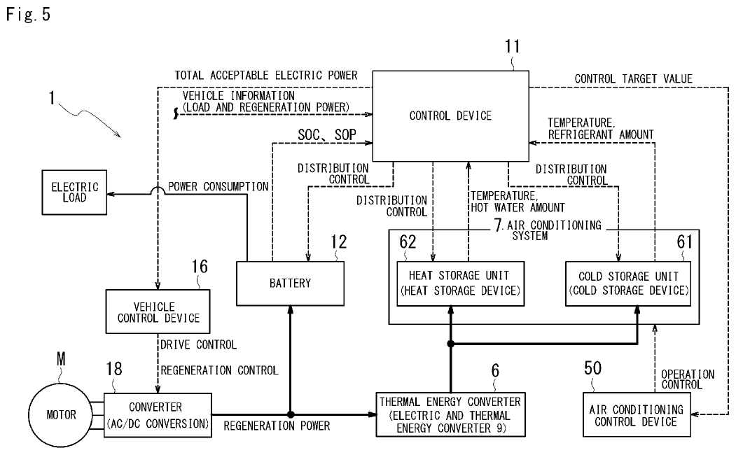

In the present embodiment, the control device 11 controls power distribution between the battery 12 and the thermal conversion device 6 (Peltier heat exchanger 90). FIG. 5 is a diagram explaining the distribution of the electric power (electric energy) by the control device 11, and is a diagram explaining regeneration power (electric energy) distribution between the battery 12, the cold storage unit 61 and the heat storage unit 62.

The control device 11 distributes the electric power (electric energy) to be outputted from the converter 18 between the battery 12 and the thermal energy converter 6 based upon a charged amount of the battery 12, a heat storage state of the heat storage unit 62 and a cold storage state of the cold storage unit 61.

The battery 12 outputs information indicating a state of charge SOC and a state of power SOP of the battery 12 to the control device 11. The cold storage unit 61 outputs information indicating a temperature and an amount (cold water amount) of the cold storage material to the control device 11. The heat storage unit 62 outputs information indicating a temperature and an amount (heat water amount) of the heat storage material to the control device 11.

Information indicating electric loads of the electric devices 5 mounted on the vehicle V and vehicle information including information of the regeneration power to be inputted are inputted into the control device 11.

The control device 11 calculates acceptable power of the cold storage unit 61 and the heat storage unit 62 based upon the information inputted from the cold storage unit 61 and the heat storage unit 62.

Here, an example of calculating the acceptable power will be explained by taking a case of the heat storage unit 62 as an example. The control device 11 specifies a heat storage amount of the heat storage unit 62 at the present point of time from the information (a temperature and an amount of the heat storage material) inputted from the heat storage unit 62. Subsequently, the control device 11 calculates a difference (acceptable thermal energy) between an upper limit value of the heat storage amount and a heat storage amount at the present point of time in the heat storage unit 62.

In addition, the control device 11 calculates electric energy (required energy) required for driving each of the thermal energy converter 6 until the acceptable thermal energy amount can be obtained. It should be noted that this required energy changes depending upon kinds of the driven thermal energy converter 6 and a combination of the driven thermal energy converter 6.

Since the calculated required power is equivalent to the maximum value of the electric power (electric energy) that can be accepted in the heat storage unit 62-side, the control device 11 defines the calculated required power as the acceptable power of the heat storage unit 62.

The control device 11 determines electric power (acceptable power) that can be accepted in the energy management system 1-side from the acceptable power of the cold storage unit 61, the acceptable power of the heat storage unit 62, and the SOC and SOP of the battery 12. The determined electric power is outputted to the vehicle control device 16.

The acceptable power that the control device 11 outputs to the vehicle control device 16 may be assumed as the SOC (heat exchange SOC) and the SOP (heat exchange SOP) in the energy management system 1-side (heat exchange side).

The vehicle control device 16 outputs information of electric power (regeneration power) to be inputted to the energy management system 1-side from the motor M at the regeneration running of the vehicle V to the control device 11. The control device 11 determines distribution of the inputted electric power between the battery 12 and the thermal energy converter 6 (electric and thermal energy converter 9) from the information of the electric power (regeneration power) to be inputted, the SOC and the SOP of the battery and the acceptable power of the heat storage equipment (the cold storage unit 61 and the heat storage unit 62).

Thereby, the electric power (regeneration power) inputted into the energy management system 1-side from the motor M is supplied to the battery 12 and the thermal energy converter 6 (electric and thermal energy converter 9) by the determined distribution.

Further, the control device 11 outputs a control target value to an air conditioning control device 50 for operating the air conditioning system 7 in an optimal efficiency. The air conditioning control device 50 controls air conditioning devices such as the compressor 73, a fan (not shown) and the like equipped in the air conditioning system 7 in response to input of the control target value to control the air conditioning of a vehicle.

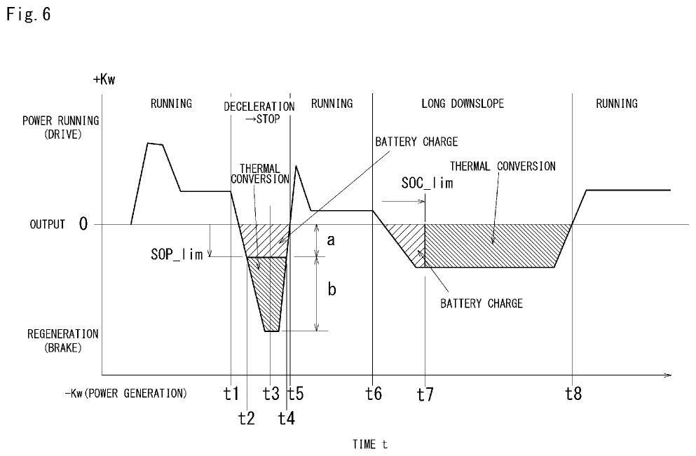

Hereinafter, an explanation will be made of the distribution of the electric power (electric energy) generated by the motor M. FIG. 6 is a time chart explaining a relation between a change in a running state of a vehicle and distribution of electric power (electric energy).

When the vehicle V running (power running) with a driving force of the motor M starts to decelerate from time t1, the power generation by the regeneration energy starts in the motor M from that point of time. Thereby, the electric power (electric energy) generated by the motor M is inputted into the energy management system 1.

In some cases, the output of the motor M at the time the vehicle decelerates exceeds an upper limit value SOP_lim of the acceptable power in the battery 12. This upper limit value SOP_lim is a variable determined in accordance with the SOC of the battery 12.

For example, in a case of FIG. 6, at time t2 the electric power outputted from the motor M exceeds the upper limit value SOP_lim of the acceptable power in the battery 12.

Therefore the control device 11, at a time point (time t2) when the electric power to be inputted from the motor M exceeds the upper limit value SOP_lim of the acceptable power, drives each of the thermal energy converter 6 to convert the electric energy into the thermal energy. In this case each of the thermal energy converter 6 is driven with the electric power equivalent to the exceeded amount of the upper limit value SOP_lim.

In a case of the conventional example where use of the thermal conversion device is not considered, the electric power equivalent to the amount exceeding the upper limit value SOP_lim of the acceptable power is disposed of without being used after time t2. In the present embodiment, the thermal energy converter 6 is driven with the electric power equivalent to the exceeded amount to convert the electric energy into the thermal energy, thus preventing the electric power from being disposed of without being used.

In a case of FIG. 6, the control device 11 adjusts the electric power to be used for driving each of the thermal energy converter 6, while holding the electric power to be inputted into the battery 12. Thereby, effectively uses the electric power to be inputted from the motor M.

Incidentally, FIG. 6 shows a case of a distribution ratio between electric power to be charged to the battery 12 and electric power to be used for the drive of the thermal energy converter 6, wherein the distribution ratio at time t3 is a:b.

After time t4, the electric power to be inputted from the motor M is used only for the charge to the battery 12. Here, time t4 is the time immediately before time t5 when the power generation in the motor M terminates due to the stop of the vehicle V.

On the other hand, also in a case where the vehicle V running (power running) with a driving force of the motor M enters a long downward slope, the power generation by the regeneration energy starts in the motor M. In this case, the electric power (electric energy) generated by the motor M is inputted into the energy management system 1 from time t6 when the vehicle V enters the long downward slope.

In a case where the output of the motor M at the time the vehicle V is running on the long downward slope does not exceed the upper limit value SOP_lim of the acceptable power in the battery 12, the battery 12 is charged with all the electric power inputted from the motor M.

In this case, the charging rate (SOC) of the battery 12 increases with an elapse of time. Therefore, the control device 11 terminates the charge of the battery 12 at a point of time (time t7) when the charging rate (SOC) of the battery 12 exceeds the upper limit value SOC_lim of the charging rate. In addition, after time t7, the control device 11 drives the thermal energy converter 6 with the electric power inputted from the motor M to convert the electric energy into the thermal energy. In addition, the drive of the thermal energy converter 6 continues until time t8 where the vehicle starts the power running.

In a case of the conventional example where the use of the thermal conversion device is not considered, the electric power supplied from the motor M is disposed of without being used after time t7. In the present embodiment, the thermal energy converter 6 is driven with the electric power inputted from the motor M to convert the electric energy into the thermal energy, thus preventing the electric power from being disposed of without being used. Thereby, the battery 12 and the thermal energy converter 6 absorb the electric energy to be effectively used, and therefore, a consumption efficiency (electric power consumption) of the electric power in the energy management system 1 can be improved.

In this way, in the present embodiment the electric energy is stored as the chemical energy in the battery 12, and on the other hand, the electric energy is stored as the thermal energy in the heat storage equipment (the cold storage unit 61 and the heat storage unit 62). Therefore, in the energy management system 1 according to the present embodiment, the inputted electric power (electric energy) is equalized between the battery 12 and the heat storage equipment (the cold storage unit 61 and the heat storage unit 62) for storage.

The control device 11 determines the distribution of the electric power for equalization by referring to: the charging state (the SOC and the SOP) of the battery 12; the heat storage state in the heat storage unit 62; the cold storage state in the cold storage unit 61; the electric loads of the electric devices 5; and the heat loads of the thermal energy converter 6 (the air conditioning system 7, the hot water heater 64 and the like).

Thereby the inputted electric power (electric energy) can be more appropriately equalized for storage than in a case of being stored in the battery 12 only or in a case of being simply distributed between the battery 12 and the thermal energy converter 6 (heat storage equipment).

Further, in the energy management system 1 the following procedure is adopted for integrally managing the thermal energy and the electric energy.

(a) The control device 11 obtains information indicating as follows: the charging state (the SOC and the SOP) of the battery 12; the heat storage state in the heat storage unit 62; the cold storage state in the cold storage unit 61; the electric loads of the electric devices 5; and the heat loads of the thermal energy converter 6 (the air conditioning system 7, the hot water heater 64 and the like).

(b) The control device 11 determines, based upon the obtained information, the distribution of the inputted electric power (electric energy) for using, in maximum extent, the capability of each of the battery 12 and the heat storage equipment (the cold storage unit 61 and the heat storage unit 62).

As a result. The following points are realized in the vehicle V on which the energy management system 1 is mounted.

(a) Collection of exhaust heat and cold heat which are normally to be wasted without being used.

(b) Suppression of a total amount of the electric power (electric energy) which are to be wasted among the inputted electric power (electric energy). Thereby, since the distribution of the inputted electric power (electric energy) is determined in consideration of an entire state of the energy management system 1, a functional value of the energy management is increased to the maximum extent.

Hereinafter, an explanation will be made of advantageous points in a case of applying the energy management system 1 according to the present embodiment to a hybrid vehicle running with driving forces of the engine and the motor M.

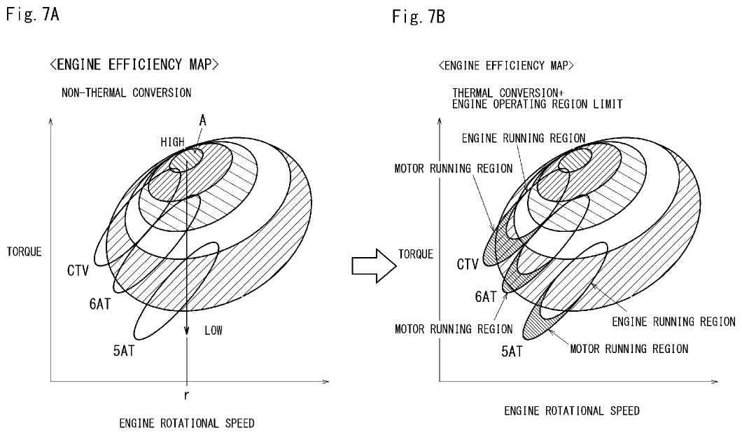

FIG. 7A and FIG. 7B are graphs explaining an engine efficiency map. FIG. 7A is an engine efficiency map in a case of a vehicle according to the conventional example where the thermal energy converter 6 are not adopted. FIG. 7B is an engine efficiency map in a case of a hybrid vehicle where the thermal energy converter 6 are adopted.

In the engine efficiency maps, distribution to a fuel efficiency amount (fuel efficiency) to an engine rotational speed and torque outputted by an engine is defined. As a general trend, the fuel efficiency in a medium-speed region is lower than in a high-speed region where the engine rotational speed is high and in a low-speed region where the engine rotational speed is low. In addition, in terms of the same engine rotational speed r, the fuel efficiency is the better as the torque is higher and is the worse as the torque is lower. Therefore, in FIG. 7A a region A is a region where the fuel efficiency is the best. The fuel efficiency is the worse according to separating away from the region A.

For example, in FIG. 7A in a case of a CVT vehicle, the vehicle control device 16 controls an engine rotational speed and engine torque using regions indicated at ellipses in the figure. In a case of a six-speed automatic transmission (6AT) and in a case of a five-speed automatic transmission (5AT), the vehicle control device 16 controls an engine rotational speed and engine torque using a region of an ellipse corresponding to each case. In the vehicle according to the conventional example, in any case it is required to control the running of the vehicle using a region where the fuel efficiency is deteriorated (a region of a left diagonal bottom in the ellipse).

In a case of the vehicle according to the present embodiment, at the deceleration running of the vehicle the electric energy obtained by the power generation of the motor M is converted not only into the chemical energy to be stored in the battery 12, but also into the thermal energy to be stored in the heat storage equipment (the cold storage unit 61 and the heat storage unit 62).

In addition, the thermal energy stored in the heat storage equipment (the cold storage unit 61 and the heat storage unit 62) is used as a thermal source of the air conditioning system 7. Thus, in the air conditioning system 7, the consumption of the electric power of the battery 12 is suppressed. Therefore, there is enough output in the electric power of the battery 12 than in a vehicle where the thermal energy converter 6 are not used.

Therefore, for example, the vehicle control device 16 is configured to positively drive the motor in a region (in a motor running region in FIG. 7B) where the fuel efficiency is poor in the engine efficiency map. Specifically in the region of the poor fuel efficiency in the engine efficiency map, the vehicle is caused to run by both of a driving force of the motor and a driving force of the engine or only by the driving force of the motor. By doing so, the drive (load) of the engine is suppressed in the region of the poor fuel efficiency and the engine can be driven in the region of the good fuel efficiency (refer to the engine running region in FIG. 7B). Therefore the fuel efficiency can be improved.

The battery 12 mounted on the vehicle is generally a battery of 12V series, but in recent years there have been used batteries having larger output, such as 48V series or 200V series. The battery has the more output as the voltage becomes larger, but the battery itself becomes large-sized. As described before, in the energy management system 1 the Peltier heat exchanger 90 can convert the thermal energy stored in the heat storage unit 62 and the cold storage unit 61 to output the electric energy.

Therefore the drives of the electric device 5 and the motor M and the charge of the battery 12 can be performed by the electric energy to be outputted from the Peltier heat exchanger 90. As a result, even in the battery of 12V series having small output, the SOC (charging rate) of the battery 12 can be prevented from lacking. Therefore the electric power demand in a vehicle can be satisfied without exchanging the battery for a battery having larger output.

Particularly, in a case of the battery of 48V series having more output, that battery has more room in electric power than the battery of 12V series. Therefore when the battery of 48V series is combined with the thermal energy converter 6 for use, it is possible to exhaustively use the electric power (electric energy) generated in the regeneration energy, and the electric power demand in the vehicle can be satisfied safely.

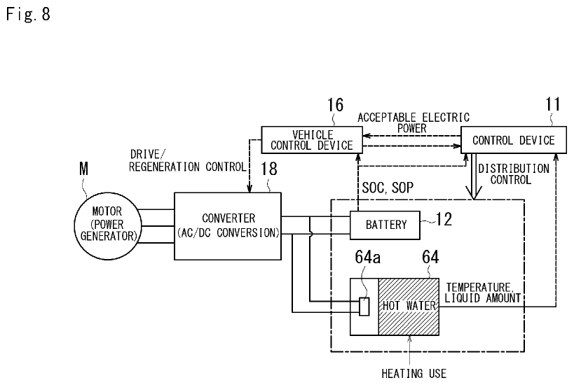

Hereinafter, there will be exemplified a case where the thermal energy converter 6 is a device other than the Peltier heat exchanger 90. FIG. 8 is a diagram explaining a case where the thermal conversion device 6 is a hot water heater 64. The hot water heater 64 has a heater 64a that heats reserved water. The hot water heater 64 is driven by the electric power (electric energy) to be supplied from the converter 18 or the battery 12 to convert the electric energy into the thermal energy.

The hot water heater 64 is structured to reserve hot water therein, and the hot water heater 64 itself functions as a heat storage unit. The hot water reserved in the hot water heater 64 is heat-exchangeable with the heating equipment 76 in the air conditioning system 7, and the hot water heater 64 acts as a supply source of heat to the air conditioning system 7.

The hot water heater 64 outputs information indicating a temperature and an amount of the hot water reserved in the hot water heater 64 to the control device 11. The control device 11 determines electric power that can be accepted (acceptable electric power) in the energy management system 1-side based upon the information from the hot water heater 64 and the SOC and SOP of the battery 12, and outputs the electric power to the vehicle control device 16.

The vehicle control device 16 outputs information of the electric power (regeneration power) inputted into the energy management system 1-side from the motor M to the control device 11 at the regeneration running of the vehicle V. The control device 11 determines the distribution of the inputted electric power between the battery 12 and the hot water heater 64 based upon the information items as follows: the information of the electric power (regeneration power) to be inputted; the SOC and SOP of the battery; the information of a temperature and a liquid amount of the hot water reserved in the hot water heater 64; and the like.

For example, when an accelerator pedal of the vehicle V running in a high speed is released, a brake force by taking out the regeneration energy from the motor M functions to decelerate the vehicle. In this case, excessive electric power exceeding the SOC or SOP of the battery 12 is possibly inputted into the energy management system 1. In such a case, the excessive electric power exceeding an acceptable capacity of the battery 12 can be collected as heat in the thermal conversion device 6-side (for example, in the hot water heater 64). Thereby the waste energy can be collected to improve an energy efficiency of the entire energy management system 1.

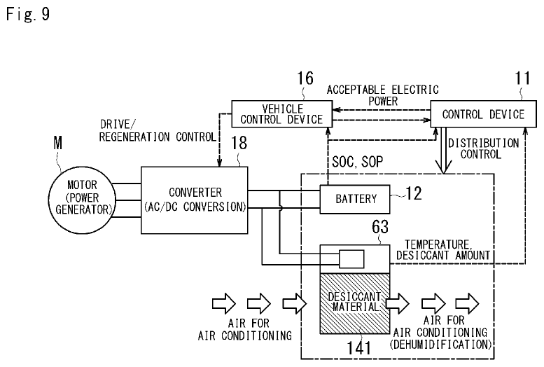

FIG. 9 is a diagram explaining a case where the thermal conversion device 6 is the electric heater 63 in the desiccant system 14. The electric heater 63 is attached to an absorbent material 141 in the desiccant system 14, and the electric heater 63 is disposed to be capable of heating the absorbent material 141. The absorbent material 141 is a material in which absorption of water components and desorption of water components by heating can be made. For example, not only an inorganic material such as zeolite, but also activated carbon, and an inorganic or organic polymer material can be used as the absorbent material 141.

For example, the absorbent material 141 is installed in a flowing path of air (air for air conditioning) whose temperature is adjusted by the air conditioning system 7. The absorbent material 141 absorbs the water components contained in the air for air conditioning to dehumidify the air for air conditioning.

The electric heater 63 is driven at the time the absorbent material 141 is saturated with the absorbed water components to heat the absorbent material 141. Thereby, the water components are desorbed from the absorbent material 141, whereby the absorbent material 141 is activated.

The electric heater 63 outputs information indicating a temperature and an absorbent amount of the absorbent material 141, and information indicating humidity of air for air conditioning that has passed through the absorbent material 141 to the control device 11. The control device 11 determines electric power that can be accepted (acceptable power) in the energy management system 1-side based upon the information from the electric heater 63 and the SOC and SOP of the battery 12, and outputs the electric power to the vehicle control device 16.

The vehicle control device 16 outputs information of the electric power (regeneration power) inputted into the energy management system 1-side from the motor M to the control device 11 at the regeneration running of the vehicle V. The control device 11 determines the distribution of the inputted electric power between the battery 12 and the electric heater 63 based upon the information items as follows: the information of the electric power (regeneration power) to be inputted; the SOC and SOP of the battery; and the information indicating a temperature and an absorption amount of the absorbent material 141.

Thereby, by activating the absorbent material 141 at timing when the fuel efficiency is not deteriorated, the excessive electric energy can be effectively used.

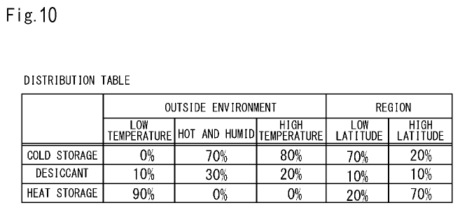

Next, an explanation will be made of a distribution example of the electric power (electric energy) inputted from the motor M-side. FIG. 10 is a diagram explaining a distribution ratio of the electric power (electric energy) inputted from the motor M-side.

In the energy management system 1, there are some cases where a plurality of the thermal energy converter 6 are simultaneously driven to prevent the electric power inputted from the motor M-side from being wasted. For example, in a case of distributing the electric energy between the cold storage unit 61 and the heat storage unit 62 in the air conditioning system 7, and the electric heater 63 in the desiccant system 14, the electric energy may be distributed in a predetermined given ratio, but the ratio of the distribution may change depending upon an outside environment.

For example, under a low-temperature environment like a winter season, a demand for cooling is low and a demand for heating is high. In the winter season where the demand for cooling is low, even when the low-temperature thermal energy is stored in the cold storage unit 61, the low-temperature thermal energy is not nearly used and therefore, is wasteful in many cases. Therefore, under the low-temperature environment like the winter season, the distribution to the cold storage unit 61 is made to zero (=0%) and the distribution to the heat storage unit 62 is made to a lot (for example, 90%). Thereby, it is possible to satisfy the heating demand certainly without wasting the thermal energy.

In addition, under a high-temperature environment like a summer season, a demand for heating is low and a demand for cooling is high. Therefore, under the high-temperature environment like the summer season, the distribution to the heat storage unit 62 is made to zero (=0%) and the distribution to the cold storage unit 61 is made to a lot (for example, 80%). Thereby, it is possible to satisfy the heating demand certainly without wasting the thermal energy. In addition, under a hot and humid environment, for example, the distribution to the heat storage unit 62 is made to zero (=0%), the distribution to the cold storage unit 61 is made to 70%, and the distribution to the desiccant system 14 is made to 30%. Thereby, it is possible to satisfy both of the cooling demand and the dehumidification demand. It should be noted that the distribution ratios as described above are taken as examples and it is possible to set an appropriate distribution ratio as needed.

Here, by specifying a region where a vehicle is used as another example of the outside environment by referring to the latitude information, a distribution ratio adjusted for each region can be set. Also in this case, the distribution to the heat storage unit 62, the distribution to the cold storage unit 61 and the distribution to the desiccant system 14 are adjusted in accordance with the outside environment, thus making it possible to appropriately respond to the heating demand, the cooling demand and the dehumidification demand.

It should be noted that the distribution of the inputted electric power (electric energy) may be determined in consideration of information such as a weather or a temperature. Also by doing so, it is possible to appropriately respond to the demand of the thermal energy.

Hereinafter, features of the energy management system 1 according to the present embodiment will be listed up together with effects thereof.

(1) The energy management system 1 according to the present embodiment includes the battery 12, the heat storage unit 62 (heat storage unit), the cold storage unit 61 (cold storage unit) and the control device 11 (controller). The control device 11 distributes the electric power inputted into the energy management system 1 among the battery 12, the heat storage unit 62 and the cold storage unit 61 by referring to: the charging state (SOC and SOP) of the battery 12; the heat storage state to the heat storage unit 62; and the cold storage state to the cold storage unit 61.

With this configuration, the inputted electric power (electric energy) is converted into the chemical energy to be stored in the battery 12. On the other hand, is converted into the thermal energy to be stored in the heat storage unit 62 and/or the cold storage unit 61. Therefore, even in a case where the electric energy cannot be stored as the chemical energy due to the SOC of the battery 12 having reached the upper limit, the electric energy can be stored as the thermal energy. As a result, the electric energy inputted into the energy management system 1 can be used in the entire energy management system 1 without being wasted.

In addition, the electric energy is distributed by referring to: the charged amount of the battery 12; the heat storage state to the heat storage unit 62; and the cold storage state to the cold storage unit 61. Thereby, the electric energy can be stored as the chemical energy and/or the thermal energy by using the electric power amount that can be accepted in the battery 12, the heat storage unit 62 and the cold storage energy 61 to the maximum extent.

The energy management system 1 according to the present embodiment has the following configuration. (2) The control device 11 calculates a maximum value of the electric power that can be inputted into the energy management system 1 by referring to: an electric power to be used by the battery 12 determined by the charging state (SOC and SOP) of the battery 12, i.e. the chargeable and dischargeable electric power of the battery 12; an electric power to be used by the heat storage unit 62 determined by with the heat storage state of the heat storage unit 62; and an electric power to be used by the cold storage unit 61 determined by the cold storage state of the cold storage unit 61. The control device 11 distributes electric power inputted from the power supply source 17 in accordance with the calculated maximum value among the battery 12, the heat storage unit 62 and the cold storage unit 61.

The electric power to be used by the battery 12 determined by the charging state (SOC and SOP) of the battery 12 is an amount (electric power amount) of the electric energy that can be stored by being converted into the chemical energy in the battery 12. The electric power to be used by the heat storage unit 62 determined by the heat storage state of the heat storage unit 62 is an amount (electric power amount) of the electric energy that can be stored by being converted into the thermal energy in the heat storage unit 62. The electric power to be used by the cold storage unit 61 determined by the cold storage state of the cold storage unit 61 is an amount (electric power amount) of the electric energy that can be stored by being converted into the thermal energy in the cold storage unit 61. The control device 11 outputs the calculated maximum value to the vehicle control device 16, and the vehicle control device 16 controls the converter 18 such that the electric power to be inputted into the energy management system 1 becomes the calculated maximum value.

With this configuration, just the right amount of the electric power that can be accepted in the energy management system 1 is supplied to the energy management system 1 and is distributed between the battery 12, the heat storage unit 62 and the cold storage unit 61. Thereby, since the electric power (electric energy) inputted from the power supply sources 17 can be distributed by using the acceptable amount of the battery 12, the heat storage unit 62 and the cold storage unit 61, the inputted electric power can be stored in the energy management system 1 without being wasted.

The energy management system 1 according to the present embodiment has the following configuration. (3) The electric power to be used by the battery 12 determined by the charged amount of the battery 12 is maximum electric power chargeable to the battery 12. This electric power is a maximum amount (maximum electric power amount) of the electric energy can be stored in the battery 12 by converting into the chemical energy. The electric power to be used by the heat storage unit 62 determined by the heat storage state of the heat storage unit 62 is maximum electric power that can be inputted into the heat storage unit 62. This electric power to be used in the heat storage unit 62 is a maximum amount (maximum electric power amount) of the electric energy can be stored in the heat storage unit 62 by being converted into the thermal energy. The electric power to be used by the cold storage unit 61 determined by the cold storage state of the cold storage unit 61 is maximum electric power that can be inputted into the cold storage unit 61. This electric power to be used by the cold storage unit 61 is a maximum amount (maximum electric power amount) of the electric energy can be stored in the cold storage unit 61 by being converted into the thermal energy.

With this configuration, the electric power inputted from the power supply source 17 can be distributed by using the acceptable capacity of the battery 12, the heat storage unit 62 and the cold storage unit 61 to the maximum extent.

The energy management system 1 according to the present embodiment has the following configuration. (4) The energy management system 1 further includes the desiccant system 14 and the hot water heater 64. The control device 11 calculates a maximum value of the electric power that can be inputted into the energy management system 1 by further referring to the electric power to be used that is determined by the state of the desiccant system 14 and the hot water heater 64. The control device 11 distributes the electric power inputted from the power supply source 17 in accordance with the calculated maximum value among the battery 12, the heat storage unit 62, the cold storage unit 61, the desiccant system 14 (electric heater 63) and the hot water heater 64.

With this configuration, since the maximum value of the electric power that can be inputted into the energy management system 1 increases, the electric power inputted from the power supply source can be more effectively used. Further, in the energy management system 1, the battery 12, the heat storage equipment (the cold storage unit 61 and the heat storage unit 62) in the air conditioning system 7, the hot water heater 64 and the electric heater 63 in the desiccant system 14 configure key components thereof. In addition, since the electric energy and the thermal energy in the key components are integrally managed, the electric power inputted from the power supply source 17 can be effectively used without being wasted.

The energy management system 1 according to the present embodiment has the following configuration. (5) The energy management system 1 further includes the electric devices 5 driven with the electric power of the battery 12, and the air conditioning system 7 (thermal device) driven by using the thermal energy stored in the heat storage unit 62 and/or the cold storage unit 61. The control device 11 calculates the maximum value of the electric power that can be inputted into the energy management system 1 by further referring to: the electric power to be used (electric loads) of the electric devices 5; and the electric power to be used determined by the thermal amount to be used in the air conditioning system 7.

With this configuration, the maximum value of the electric power that can be inputted into the energy management system 1 is calculated in consideration of the electric power to be used in the electric device and the electric power to be used determined by the thermal amount to be used in the thermal device. That is, since the electric power to be inputted from the power supply source 17 is determined in consideration of the loads of the electric device and the thermal device, the inputted electric power can be more effectively used. Further, since the inputted electric power is distributed in consideration of the loads of the electric device and the thermal device, the inputted electric power can be efficiently used.

The energy management system 1 according to the present embodiment has the following configuration. (6) The control device 11 adjusts the distribution of the inputted electric power in accordance with the state of the outside environment.

For example, in the winter season at a low temperature, the distribution ratio is adjusted such that the thermal energy heat-stored in the heat storage unit 62 is larger than the thermal energy cold-stored in the cold storage unit 61. In addition, in the summer season at a high temperature, the distribution ratio is adjusted such that the thermal energy heat-stored in the heat storage unit 62 is smaller than the thermal energy cold-stored in the cold storage unit 61. Since the outside environment differs largely between the winter season and the summer season, the distribution of the inputted electric power is adjusted in accordance with the state of the outside environment, thus making it possible to certainly respond to the heating demand and the cooling demand.

The energy management system 1 according to the present embodiment has the following configuration. (7) There is further provided with the Peltier heat exchanger 90 (the electric and thermal conversion device) configured to simultaneously generate the thermal energy that is heat-stored in the heat storage unit 62 and the thermal energy that is cold-stored in the cold storage unit 61 by power supply.

With this configuration, the single electric and thermal conversion device is used to be capable of simultaneously generating the high-temperature thermal energy and the low-temperature thermal energy from the electric energy. Since it is not necessary to prepare for the heat exchanger generating the high-temperature thermal energy and the heat exchanger generating the low-temperature thermal energy separately, large-sizing of the energy management system 1 can be prevented appropriately.

In addition, the Peltier heat exchanger 90 can generate the electric energy from the high-temperature thermal energy and the low-temperature thermal energy. The electric energy distributed to the Peltier heat exchanger 90 as one of the thermal energy converter 6 is converted into the thermal energy, and thereafter, is stored in the heat storage equipment (the cold storage unit 61 and the heat storage unit 62) and can be taken out as the thermal energy or the electric energy as needed.

Therefore, the thermal energy stored in the heat storage equipment (the cold storage unit 61 and the heat storage unit 62) can be used for not only the air conditioning system 7 but also the drive of the electric device 5 and the charge of the battery 12. As a result, the electric energy and the thermal energy can mutually interchange in the energy management system 1. In addition, without wastefully disposing of the electric energy inputted into the energy management system 1, the electric power (electric energy) inputted from the power supply source 17 can be effectively used in the entire energy management system 1.

It should be noted that the energy management system 1 according to the present embodiment can be specified as the following configuration as well. (8) The energy management system 1 includes the heat storage unit 62 (heat storage device), the cold storage unit 61 (cold storage device) and the control device 11 (controller). The control device 11 distributes the electric power inputted into the energy management system 1 between the heat storage unit 62 and the cold storage unit 61 by referring to the maximum electric power that can be inputted into the heat storage unit 62 and the maximum electric power that can be inputted into the cold storage unit 61. The maximum electric power that can be inputted into the heat storage unit 62 is the maximum amount (maximum electric power amount) of the electric energy that can be stored by being converted into the thermal energy in the heat storage unit 62. The maximum electric power that can be inputted into the cold storage unit 61 is the maximum amount (maximum electric power amount) of the electric energy that can be stored by being converted into the thermal energy in the cold storage unit 61.

With this configuration, the electric power inputted into the energy management system 1 can be appropriately distributed for effective use and the inputted electric power can be efficiently used.

As described above, the embodiment of the present invention is explained. The present invention is not limited only to the configuration in the above-mentioned embodiment, but includes various alternations and improvements made possible within the scope of the technical concept of the present invention.

### EXPLANATION OF REFERENCE NUMBERS

1 energy management system
11 control device
12 battery
14 desiccant system
141 absorbent material
15 vehicle information network
16 vehicle control device
17 power supply sources
18 converter
5 electric device
50 air conditioning control device
51 headlight controlling device
6 thermal energy converter
61 cold storage unit
62 heat storage unit
63 electric heater
64 hot water heater
64a heater
7 air conditioning system
70 circulation path
71 evaporator
72 condenser
73 compressor
74 liquid tank
75 expansion valve
76 heating equipment
77 cooling equipment
80A, 80B circulation path
81A, 81B circulation path
82A, 82B circulation path
83A, 83B circulation path
84A circulation path
85A, 85B distributor
86 first heat collector
87 second heat collector
88 first cold collector
89 second cold collector
9 electric and thermal conversion device
90 Peltier heat exchanger
M motor
M1, M2, M3 heat exchange media
P pump
V vehicle (electric car, hybrid vehicle)

1. An energy management system comprising:
a battery;
a heat storage unit;
a cold storage unit; and
a controller, wherein:
when a regeneration power inputted into the energy management system from a power supply source exceeds a chargeable and dischargeable electric power of the battery while a charged amount of the battery has not reached an upper limit, the controller distributes electric power inputted into the energy management system among the battery, the heat storage unit and the cold storage unit by referring to: the charged amount and the chargeable and dischargeable electric power of the battery; a heat storage state of the heat storage unit; and a cold storage state of the cold storage unit, and
the electric power equivalent to the amount exceeding the chargeable and dischargeable electric power are distributed between the heat storage unit and the cold storage unit.

2. The energy management system according to claim 1, wherein the controller:
calculates a maximum value of the electric power that can be inputted into the energy management system by referring to: an electric power to be used by the battery determined by the charged amount and the chargeable and dischargeable electric power; an electric power to be used by the heat storage unit determined by the heat storage state; and an electric power to be used by the cold storage unit determined by the cold storage state; and
when the regeneration power inputted into the energy management system from the power supply source exceeds the chargeable and dischargeable electric power, the controller distributes electric power equivalent to the amount exceeding the chargeable and dischargeable electric power between the heat storage unit and the cold storage unit, restricting the inputted regeneration power to the calculated maximum value.

3. The energy management system according to claim 2, wherein
the electric power to be used by the battery is a maximum electric power chargeable to the battery,
the electric power to be used by the heat storage unit is a maximum electric power that can be inputted into the heat storage unit, and
the electric power to be used by the cold storage unit is a maximum electric power that can be inputted into the cold storage unit.

4. The energy management system according to claim 3, further comprising:
a desiccant system, wherein
the controller calculates a maximum value of the electric power that can be inputted into the energy management system by further referring to an electric power to be used by the desiccant system determined by a state of the desiccant system; and
the controller distributes the regeneration power inputted from the power supply source in accordance with the calculated maximum value among the battery, the heat storage unit, the cold storage unit and the desiccant system.

5. The energy management system according to claim 2, further comprising:
an electric device driven by the electric power of the battery; and
a thermal device driven by thermal energy stored in the heat storage unit or the cold storage unit, wherein
the controller calculates a maximum value of the electric power that can be inputted into the energy management system by further referring to an electric power to be used by the electric device and an electric power to be used by the thermal device determined by a thermal amount used by the thermal device.

6. The energy management system according to claim 2, wherein the controller adjusts the distribution of the inputted regeneration power in accordance with a state of an outside environment.

7. The energy management system according to claim 1, further comprising:
an electric and thermal energy converter configured to simultaneously convert the thermal energy to be stored in the heat storage unit and the thermal energy to be stored in the cold storage unit from the electric energy.

8. (canceled)
